(19) United States
(12) Patent Application Publication
(10) Pub. No.: US 2002/0104199 A1
(43) Pub. Date: Aug. 8, 2002

(54) Paper clip with multiple overlapped clipping portions

(76) Inventor: Jung-Hua Chen, Taichung Hsien (TW)

Correspondence Address: Alan Kamrath, RIDER BENNETT EGAN & ARUNDEL, LLP, 333 South Seventh Street, Suite 2000, Minneapolis, MN, 55402, US

(21) Appl. No.: 09/797,302

(22) Filed: Mar. 1, 2001

(30) Foreign Application Priority Data
Feb. 2, 2001 (TW) 90201767

(51) Int. Cl. B42F 1/02

(52) U.S. Cl. 24/67.9

(57) ABSTRACT

A paper clip is formed by means of bending a metal wire to form at least three overlapped clipping portions, each clipping portion and an adjacent clipping portion defining a clipping space therebetween. Each clipping portion has a first end and a second end. The second ends of the three clipping portions are superimposed one another along a vertical plane or a horizontal plane. The first ends of the clipping portions overlap with each other with a portion of the first end of a lower clipping portion offsetting from the first end of an upper clipping portion.

### BACKGROUND OF THE INVENTION

1. Field of the Invention

The present invention relates to a paper clip with multiple overlapped clipping portions, and more particularly to a paper clip formed by means of bending a metal wire to form a plurality of overlapped clipping portions for improved clipping applications.

2. Description of the Related Art

FIG. 1 of the drawings illustrates a conventional paper clip for clipping a note or a group of paper sheets. The paper clip is formed by bending a metal clip to form four legs and three bends, thereby providing a single clipping function between a first clipping section 1 and a second clipping section 2. It is, thus, impossible to use a single paper clip to clip different groups of documents that require proper grouping or classification. As a result, several paper clips are required and relevant documents are separate from each other.

### SUMMARY OF THE INVENTION

It is the primary object of the present invention to provide an improved paper clip formed by means of bending a metal wire to form a plurality of overlapped clipping portions for improved clipping applications.

In accordance with the present invention, a paper clip is formed by means of bending a metal wire to form at least three overlapped clipping portions, each clipping portion and an adjacent clipping portion defining a clipping space therebetween.

In an embodiment of the invention, a paper clip comprises:

a first clipping portion including a first end and a second end;

a second clipping portion including a first end connected to the second end of the first clipping portion and a second end, a first clipping space being defined between the first end of the second clipping portion and the first end of the first clipping portion, the second end of the first clipping portion being superimposed on the second end of the second clipping portion;

a third clipping portion including a first end connected to the second end of the second clipping portion and a second end, a second clipping space being defined between the first end of the third clipping portion and the first end of the second clipping portion, the second end of the second clipping portion being superimposed on the second end of the third clipping portion; and

a fourth clipping portion including a first end connected to the second end of the third clipping portion and a second end, a third clipping space being defined between the first end of the fourth clipping portion and the first end of the third clipping portion, the second end of the third clipping portion being superimposed on the second end of the fourth clipping portion.

The first ends of first clipping portion, the second clipping portion, the third clipping portion, and the fourth clipping portion overlap with each other with a portion of the first end of a lower clipping portion offsetting from the first end of an upper clipping portion. The second ends of first clipping portion, the second clipping portion, the third clipping portion, and the fourth clipping portion are superimposed one another along a vertical plane. A magnet is attached to the superimposed second ends of the first clipping portion, the second clipping portion, the third clipping portion, and the fourth clipping portion.

In an alternative embodiment of the invention, the second ends of first clipping portion, the second clipping portion, the third clipping portion, and the fourth clipping portion are superimposed one another along a horizontal plane. The first clipping portion, the second clipping portion, the third clipping portion, and the fourth clipping portion are arranged in a helical manner. The first end of an inner clipping portion is located at a level above than the first end of an outer clipping portion.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a conventional paper clip.

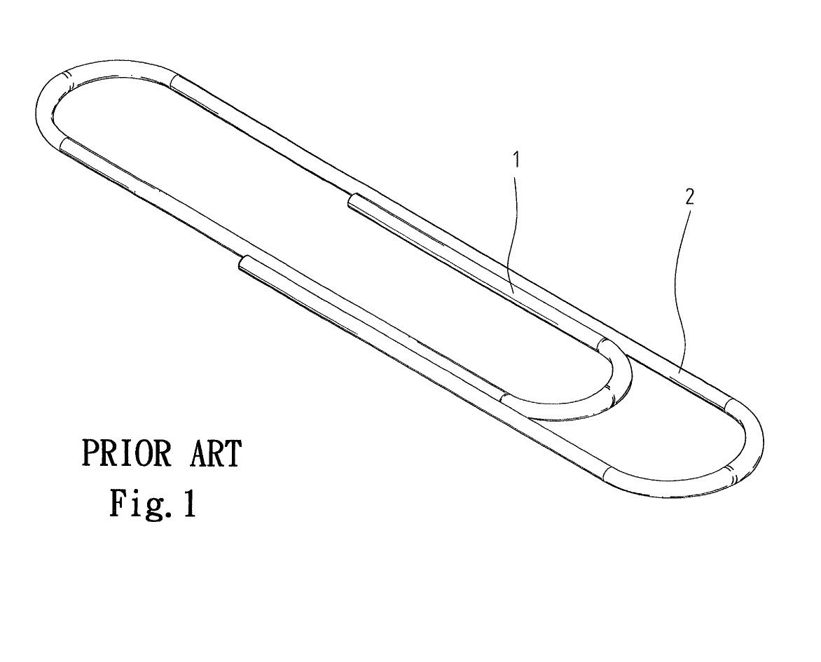

FIG. 2 is a perspective view of a first embodiment of a paper clip in accordance with the present invention.

FIG. 3 is a perspective view of a second embodiment of the paper clip in accordance with the present invention.

FIG. 4 is a perspective view of a third embodiment of the paper clip in accordance with the present invention.

FIG. 5 is a perspective view of a fourth embodiment of the paper clip in accordance with the present invention.

FIG. 6 is a perspective view illustrating a fifth embodiment of the paper clip in accordance with the present invention.

FIG. 7 is a perspective view illustrating a modification of the second embodiment of the paper clip in accordance with the present invention.

FIG. 8 is a schematic view illustrating attachment of the paper clips in accordance with the present invention to an outer surface of a refrigerator.

FIG. 9 is a schematic view illustrating use of the paper clips in accordance with the present invention.

FIG. 10 is a perspective view illustrating a further application of the paper clips in accordance with the present invention.

### DETAILED DESCRIPTION OF THE PREFERRED EMBODIMENTS

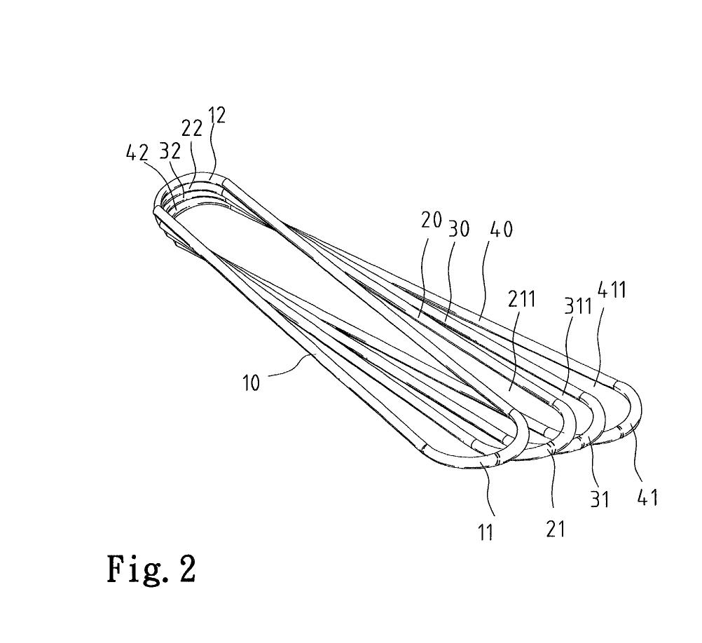

Referring to FIG. 2, a first embodiment of a paper clip in accordance with the present invention is formed by bending a metal wire to form a first clipping portion 10, a second clipping portion 20, a third clipping portion 30, and a fourth clipping portion 40. The first clipping portion 10 includes two parallel lateral sides and two opposite bends interconnecting the lateral sides. In this embodiment, the beds form an arcuate first end 11 and a second end 12. The first clipping portion 10 includes two parallel lateral legs and two opposite bends interconnecting the lateral legs. In this embodiment, the bends form an arcuate first end 11 and an arcuate second end 12. The second clipping portion 20 includes two parallel lateral legs and two opposite bends interconnecting the lateral legs. In this embodiment, the bends form an arcuate first end 21 and an arcuate second end 22. The first end 21 of the second clipping portion 20 is connected to the second end 12 of the first clipping portion 10. A first clipping space 211 is defined between the first end 21 of the second clipping portion 20 and the first end 11 of the first clipping portion 10 for clipping a note or a stack of paper sheets. The second end 12 of the first clipping portion 10 is superimposed on the second end 22 of the second clipping portion 20.

The third clipping portion 3 also includes two parallel lateral legs and two opposite bends interconnecting the lateral legs. In this embodiment, the bends form an arcuate first end 31 and an arcuate second end 32. The first end 31 of the third clipping portion 30 is connected to the second end 22 of the second clipping portion 20. A second clipping space 311 is defined between the first end 31 of the third clipping portion 30 and the first end 21 of the second clipping portion 20. The second end 22 of the second clipping portion 20 is superimposed on the second end 32 of the third clipping portion 30.

The fourth clipping portion 4 also includes two parallel lateral legs and two opposite bends interconnecting the lateral legs. In this embodiment, the bends form an arcuate first end 41 and an arcuate second end 42. The first end 41 of the fourth clipping portion 40 is connected to the second end 32 of the third clipping portion 30. A third clipping space 411 is defined between the first end 41 of the fourth clipping portion 40 and the first end 31 of the third clipping portion 30. The second end 32 of the third clipping portion 30 is superimposed on the second end 42 of the fourth clipping portion 40.

Thus, three separate and independent clipping spaces 211, 311, and 411 are provided for different groups of documents. In addition, the first ends 11, 21, 31, and 41 of the four clipping portions 10, 20, 30, and 40 overlap with each other with a portion of the first end (e.g., the second clipping portion 21) of a lower clipping portion (e.g., the second clipping portion 20 offsetting from the first end 11 of an upper clipping portion (e.g., the first clipping portion 11). This allows the user to recognize and thus classify different documents.

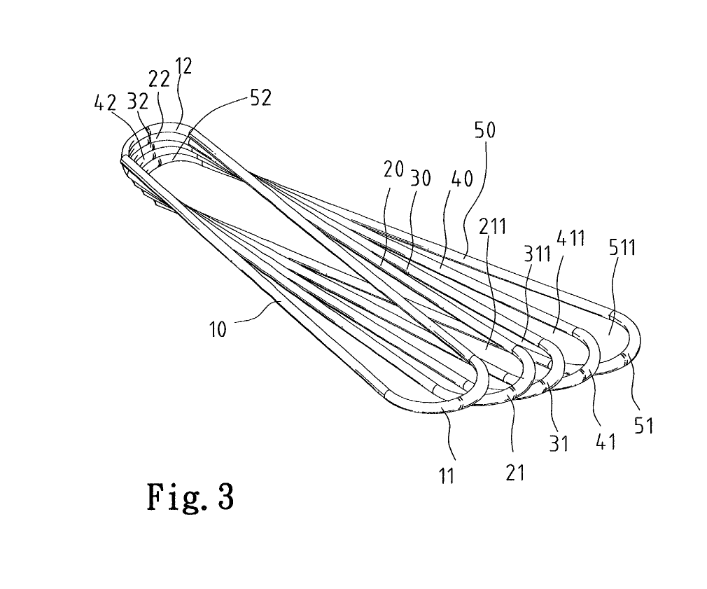

The first ends of the four clipping portions 10, 20, 30, and 40 in FIG. 2 are superimposed one another along a vertical plane. FIG. 3 illustrates a second embodiment of the paper clip, wherein the paper clip further includes a fifth clipping portion 50. The fifth clipping portion 50 includes a first end 51 connected to the second end 42 of the fourth clipping portion 40 and a second end 52. A fourth clipping space 511 is defined between the first end 51 of the fifth clipping portion 50 and the first end 41 of the fourth clipping portion 40. The second end 42 of the fourth clipping portion 40 is superimposed on the second end 52 of the fifth clipping portion 50.

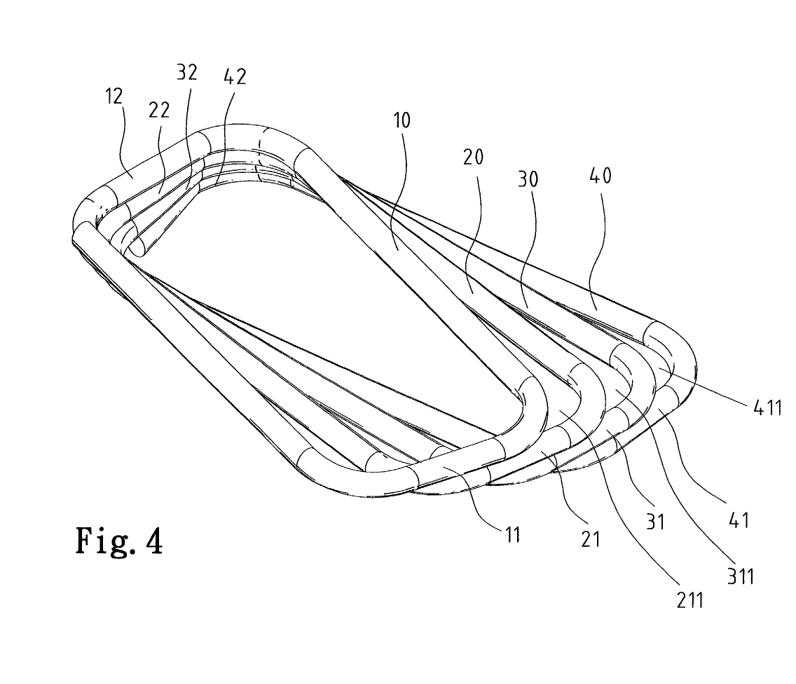

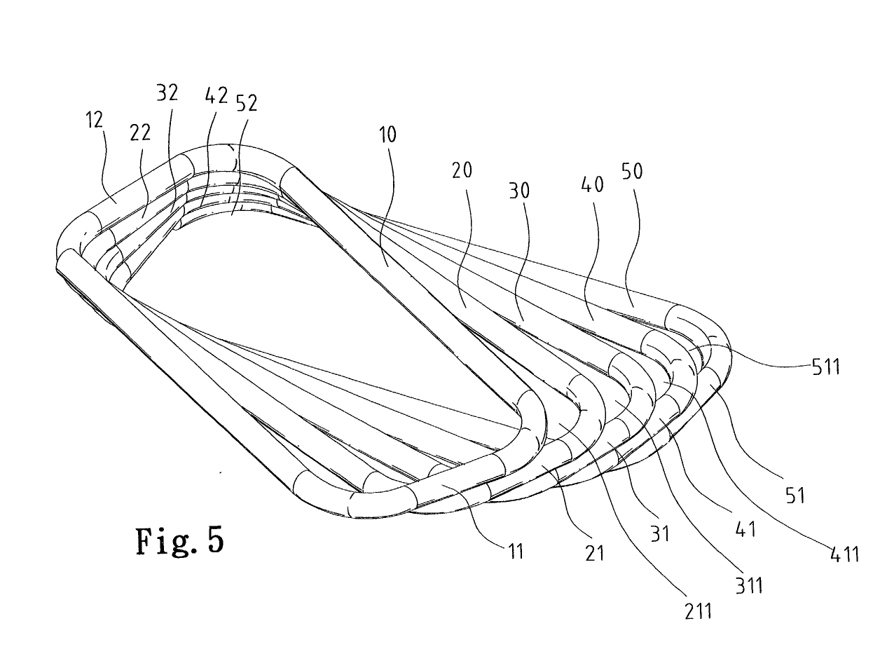

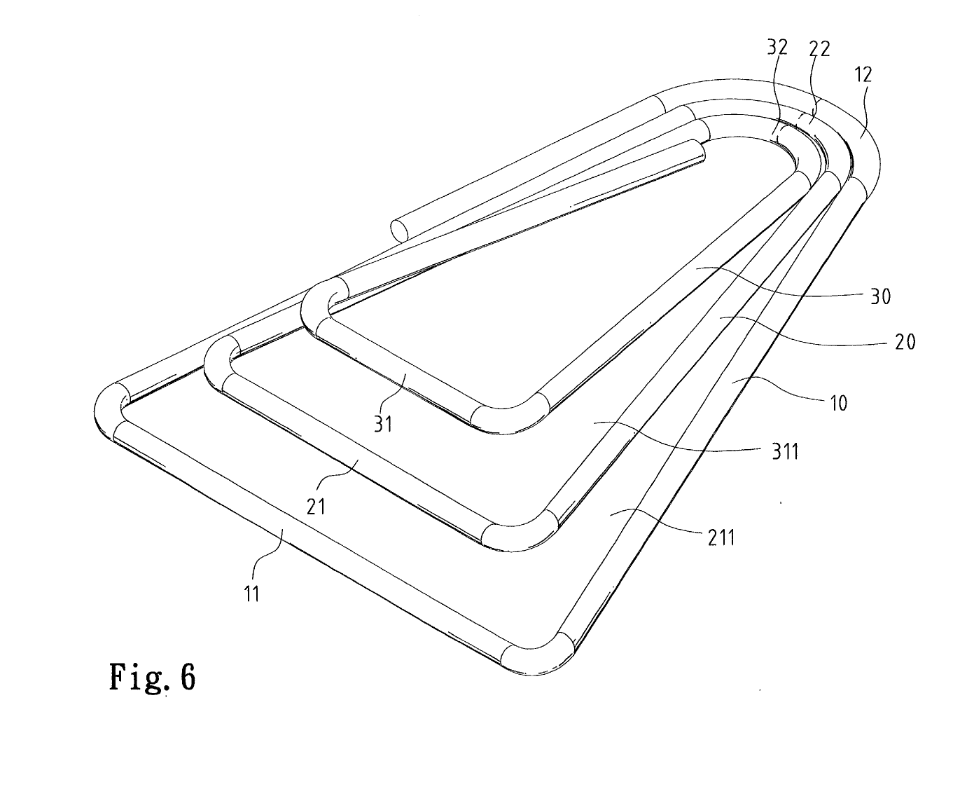

FIG. 4 illustrates a third embodiment of the paper clip, wherein the clipping portions are substantially rectangular. FIG. 5 illustrates a fourth embodiment that is modified from the third embodiment, wherein a further clipping portion 50 is provided to provide an additional clipping space 511. FIG. 6 illustrates a fifth embodiment of the paper clip, wherein the clipping portions 10, 20, and 30 are substantially triangular. In addition, the second ends 12, 22, 32 of the three clipping portions 10, 20, and 30 are superimposed one another along a horizontal plane. In addition, the three clipping portions 10, 20, and 30 are arranged in a helical manner. As illustrated in FIG. 6, the first end (e.g., 21) of an inner clipping portion (e.g., the second clipping portion 20) is located at a level above than the second end (e.g., 11) of an outer clipping portion (e.g., the first clipping portion 10).

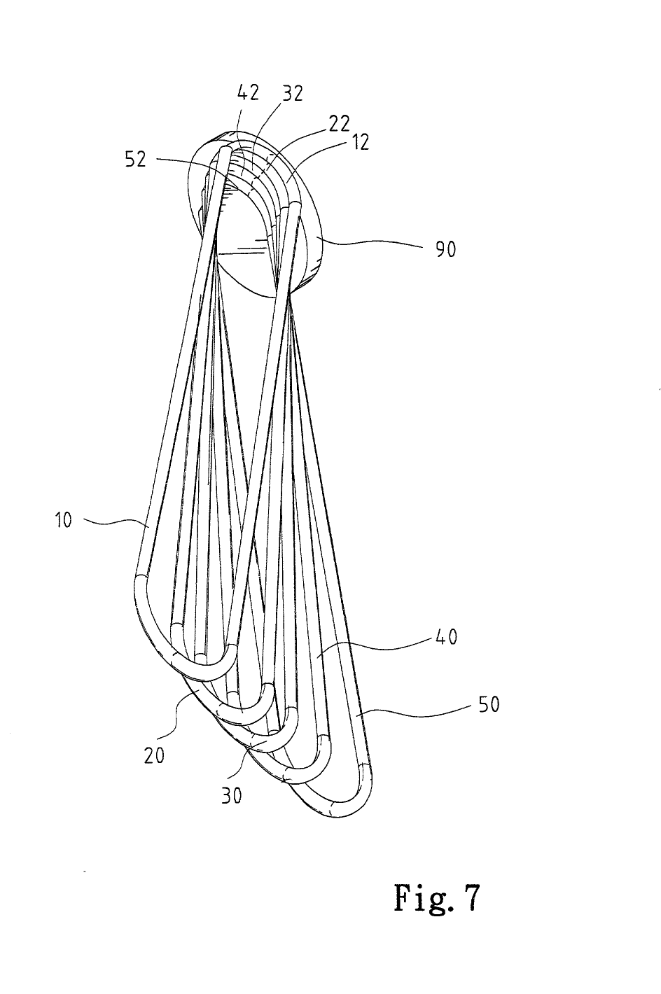

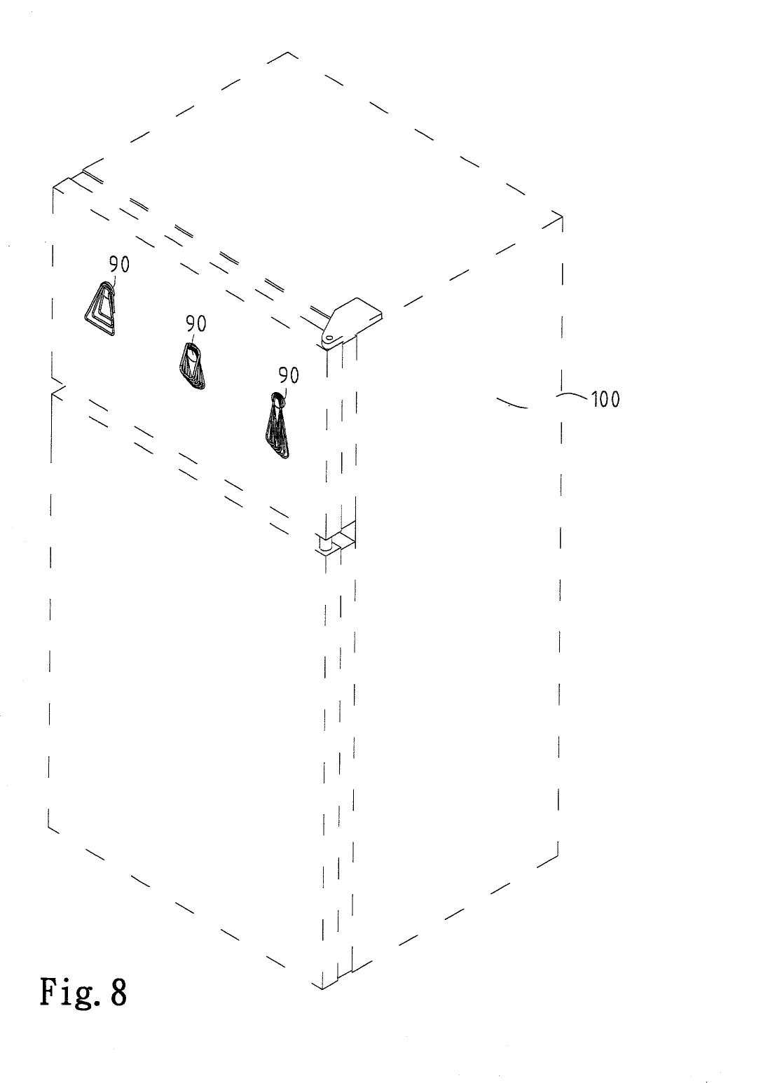

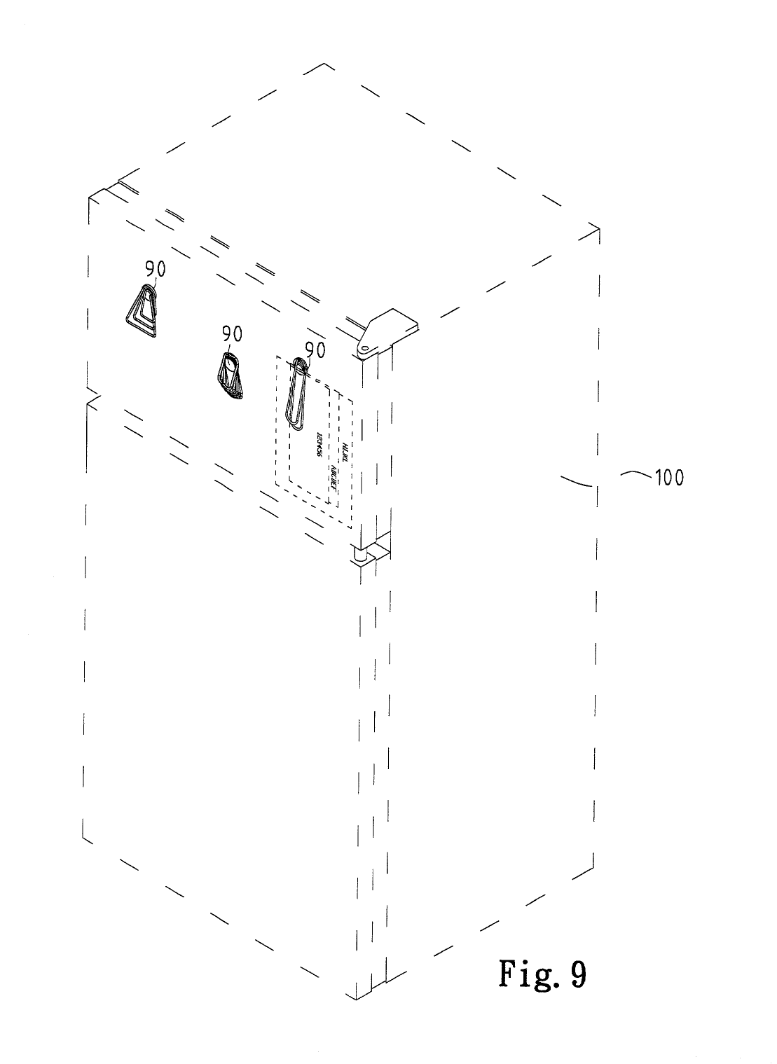

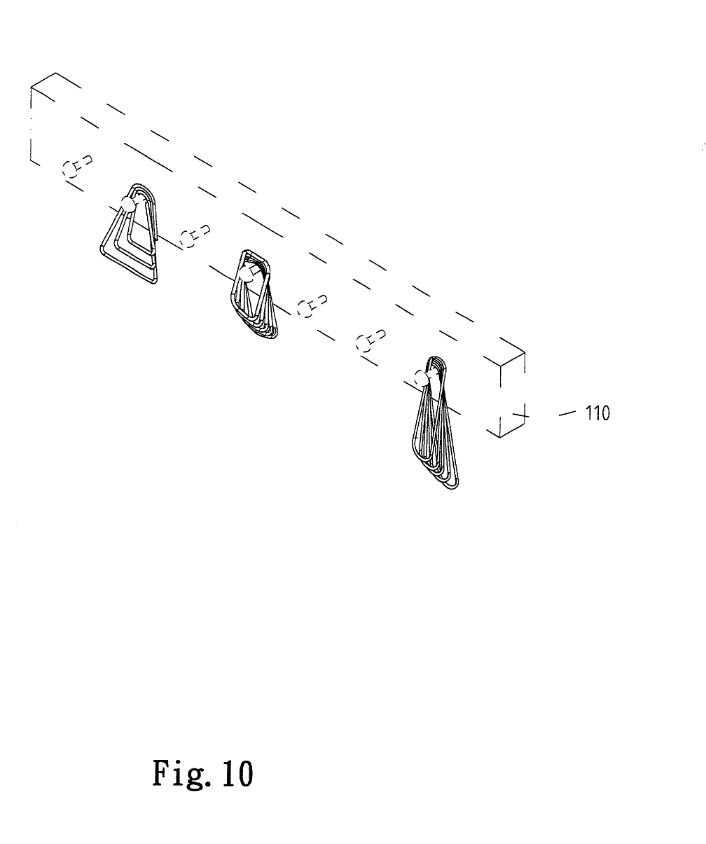

FIG. 7 illustrates a further embodiment of the clip, wherein a magnet 90 is attached to the superimposed second ends 12, 22, 32, 42, 52 of the clipping portions 10, 20, 30, 40, and 50. Thus, the paper clip can be attached to an outer surface of, e.g., a refrigerator 100 for clipping notes or the like, as shown in FIGS. 8 and 9. FIG. 10 illustrates different application of the paper clips, wherein the superimposed second ends of the paper clip in accordance with the present invention can be hung up to a nail or the like on a hanger rod 110 or the like.

Although the invention has been explained in relation to its preferred embodiment, it is to be understood that many other possible modifications and variations can be made without departing from the scope of the invention as hereinafter claimed.

What is claimed is:

1. A paper clip formed by means of bending a metal wire to form at least three overlapped clipping portions, each said clipping portion and an adjacent said clipping portion defining a clipping space therebetween.

2. The paper clip as claimed in claim 1, wherein each said clipping portion is triangular.

3. The paper clip as claimed in claim 1, wherein each said clipping portion is rectangular.

4. The paper clip as claimed in claim 1, wherein each said clipping portion includes two parallel lateral legs and two opposite bends interconnecting the lateral legs.

5. The paper clip as claimed in claim 1, wherein each said clipping portion has a first end and a second end, the second ends of said at least three clipping portions being superimposed one another.

6. The paper clip as claimed in claim 5, wherein the first ends of said at least three clipping portions overlap with each other with a portion of the first end of a lower said clipping portion offsetting from the first end of an upper said clipping portion.

7. The paper clip as claimed in claim 5, wherein the second ends of said at least three clipping portions are superimposed one another along a vertical plane.

8. The paper clip as claimed in claim 5, wherein the second ends of said at least three clipping portions are superimposed one another along a horizontal plane.

9. The paper clip as claimed in claim 8, wherein said at least three clipping portions are arranged in a helical manner.

10. The paper clip as claimed in claim 9, wherein the first end of an inner said clipping portion is located at a level above than the first end of an outer said clipping portion.

11. The paper clip as claimed in claim 5, further comprising a magnet attached to the superimposed second ends of said at least three clipping portions.

12. A paper clip comprising:
a first clipping portion including a first end and a second end;
a second clipping portion including a first end connected to the second end of the first clipping portion and a second end, a first clipping space being defined between the first end of the second clipping portion and the first end of the first clipping portion, the second end of the first clipping portion being superimposed on the second end of the second clipping portion;
a third clipping portion including a first end connected to the second end of the second clipping portion and a second end, a second clipping space being defined between the first end of the third clipping portion and the first end of the second clipping portion, the second end of the second clipping portion being superimposed on the second end of the third clipping portion; and
a fourth clipping portion including a first end connected to the second end of the third clipping portion and a second end, a third clipping space being defined between the first end of the fourth clipping portion and the first end of the third clipping portion, the second end of the third clipping portion being superimposed on the second end of the fourth clipping portion.

13. The paper clip as claimed in claim 12, wherein the first ends of first clipping portion, the second clipping portion, the third clipping portion, and the fourth clipping portion overlap with each other with a portion of the first end of a lower said clipping portion offsetting from the first end of an upper said clipping portion.

14. The paper clip as claimed in claim 13, wherein the second ends of first clipping portion, the second clipping portion, the third clipping portion, and the fourth clipping portion are superimposed one another along a vertical plane.

15. The paper clip as claimed in claim 13, wherein the second ends of first clipping portion, the second clipping portion, the third clipping portion, and the fourth clipping portion are superimposed one another along a horizontal plane.

16. The paper clip as claimed in claim 15, wherein the first clipping portion, the second clipping portion, the third clipping portion, and the fourth clipping portion are arranged in a helical manner.

17. The paper clip as claimed in claim 16, wherein the first end of an inner said clipping portion is located at a level above than the first end of an outer said clipping portion.

18. The paper clip as claimed in claim 12, further comprising a magnet attached to the superimposed second ends of the first clipping portion, the second clipping portion, the third clipping portion, and the fourth clipping portion.

19. The paper clip as claimed in claim 12, therein each said clipping portion is triangular.

20. The paper clip as claimed in claim 12, wherein each said clipping portion is rectangular.
